(19) United States
(12) Patent Application Publication
(10) Pub. No.: US 2024/0215486 A1
(43) Pub. Date: Jul. 4, 2024

(54) AUGER DRIVE ASSEMBLY FOR AN AGRICULTURAL HARVESTER

(71) Applicant: CNH Industrial America LLC, New Holland, PA (US)

(72) Inventors: Eric Fredricks, II, Davenport, IA (US); Thamilselvan Karuppannan, Bettendorf, IA (US); Cory M. Conway, Maquoketa, IA (US); Brian P. Crow, Rock Island, IL (US)

(21) Appl. No.: 18/563,714

(22) PCT Filed: May 24, 2022
(86) PCT No.: PCT/US2022/030714

§ 371 Date: Nov. 22, 2023

Related U.S. Application Data
(60) Provisional application No. 63/192,380, filed on May 24, 2021.

(51) Int. Cl. A01D 41/14

(52) U.S. Cl. CPC A01D 41/142

(57) ABSTRACT

A multi-segment header (102) for an agricultural harvester. The multi¬segment header (102) includes a chassis (104), a multi-segment auger (110) supported by the chassis, and a drive assembly (120) centrally located with respect to the chassis for rotatably driving the multi-segment auger. The multi-segment auger includes a first auger segment (112) and a second auger segment (114). The drive assembly (120) includes a motor (130) spaced from the multi¬segment auger (110) and a driven shaft (138) operatively engaged with the motor, and the first and second auger segments.

The exemplary embodiments of the present invention relate generally to a multi-segment header for an agricultural harvester having an offset hydraulic drive.

### BACKGROUND OF THE INVENTION

An agricultural harvester e.g., a plant cutting machine, such as, but not limited to, a combine or a windrower, generally includes a header operable for severing and collecting plant or crop material as the harvester is driven over a crop field. The header has a plant cutting mechanism, e.g., a cutter bar, for severing the plants or crops via, for example, an elongate sickle mechanism that reciprocates sidewardly relative to a non-reciprocating guard structure. After crops are cut, they are collected inside the header and transported via a conveyor such as an auger towards a feederhouse located centrally inside the header.

Conventional agricultural harvester headers often include two or more adjacent augers that are driven by hydraulic motors mounted at the ends of the header. A disadvantage with providing motors and driving mechanisms at the end of the header is that multiple hydraulic assemblies are required for various header sizes which creates complexity for engineering, manufacturing, service and higher costs. Further, with conventional center mounted motors on the augers, they result in a large dead spot on the auger due to the presence of the motors where cut crop is unable to be effectively compressed and conveyed by the auger.

### SUMMARY OF THE INVENTION

In accordance with an exemplary embodiment, the present disclosure provides a multi-segment header for an agricultural harvester. The multi-segment header includes a chassis, a multi-segment auger supported by the chassis, and a drive assembly centrally located with respect to the chassis for rotatably driving the multi-segment auger. The multi-segment auger includes a first auger segment and a second auger segment. The drive assembly includes a motor spaced from the multi-segment auger and a driven shaft operatively engaged with the motor, and the first and second auger segments.

In accordance with an aspect of an exemplary embodiment, the drive assembly includes a housing, first and second sprockets housed within the housing, and an endless belt extending between the first and second sprockets. The motor is adjacent a posterior end of the housing and the driven shaft is operatively engaged with one of the first and second sprockets.

Other features and advantages of the subject disclosure will be apparent from the following more detailed description of the exemplary embodiments.

### BRIEF DESCRIPTION OF THE DRAWINGS

The foregoing summary, as well as the following detailed description of the exemplary embodiments of the subject disclosure, will be better understood when read in conjunction with the appended drawings. For the purpose of illustrating the subject disclosure, there are shown in the drawings exemplary embodiments. It should be understood, however, that the subject disclosure is not limited to the precise arrangements and instrumentalities shown. In the drawings:

FIG. 1 is a front perspective view of an agricultural harvester including a header having a multi-segment auger;

FIG. 2 is a front view of an agricultural harvester header in accordance with an exemplary embodiment of the subject disclosure;

FIG. 3 is an enlarged partial perspective view of a portion of the agricultural harvester header of FIG. 2;

FIG. 4 is an enlarged perspective view of the agricultural harvester header of FIG. 3 with certain elements omitted for purposes of illustration;

FIG. 5 is another enlarged perspective view of the agricultural harvester header of FIG. 3 with certain elements shown in phantom for purposes of illustration;

FIG. 6 is an isolated perspective view of a drive assembly of the agricultural harvester header of FIG. 2 with certain elements shown in phantom for purposes of illustration;

FIG. 7 is another perspective view of the drive assembly of FIG. 6;

FIG. 8 is an isolated perspective view of a drive assembly of the agricultural harvester header of FIG. 2;

FIG. 9 is a partial cross-sectional perspective view of a drive assembly of the agricultural harvester header of FIG. 2 with certain elements shown in phantom for purposes of illustration; and

FIG. 10 is an isolated side view of another exemplary embodiment of a drive assembly of the subject disclosure having an idler sprocket and with certain elements omitted for purposes of illustration.

### DETAILED DESCRIPTION OF THE DRAWINGS

Reference will now be made in detail to the various exemplary embodiments of the subject disclosure illustrated in the accompanying drawings. Wherever possible, the same or like reference numbers will be used throughout the drawings to refer to the same or like features. It should be noted that the drawings are in simplified form and are not drawn to precise scale. Certain terminology is used in the following description for convenience only and is not limiting. Directional terms such as top, bottom, left, right, above, below and diagonal, are used with respect to the accompanying drawings. The term “distal” shall mean away from the center of a body. The term “proximal” shall mean closer towards the center of a body and/or away from the “distal” end. The words “inwardly” and “outwardly” refer to directions toward and away from, respectively, the geometric center of the identified element and designated parts thereof. Such directional terms used in conjunction with the following description of the drawings should not be construed to limit the scope of the subject application in any manner not explicitly set forth. Additionally, the term “a,” as used in the specification, means “at least one.” The terminology includes the words above specifically mentioned, derivatives thereof, and words of similar import.

The terms “grain,” “ear,” “stalk,” “leaf,” and “crop material” are used throughout the specification for convenience and it should be understood that these terms are not intended to be limiting. Thus, “grain” refers to that part of a crop which is harvested and separated from discardable portions of the crop material. The header of the subject application is applicable to a variety of crops, including but not limited to wheat, soybeans and small grains. The terms “debris,” “material other than grain,” and the like are used interchangeably.

“About” as used herein when referring to a measurable value such as an amount, a temporal duration, and the like, is meant to encompass variations of ±20%, ±10%, ±5%, ±1%, or ±0.1% from the specified value, as such variations are appropriate.

“Substantially” as used herein shall mean considerable in extent, largely but not wholly that which is specified, or an appropriate variation therefrom as is acceptable within the field of art. “Exemplary” as used herein shall mean serving as an example.

Throughout the subject application, various aspects thereof can be presented in a range format. It should be understood that the description in range format is merely for convenience and brevity and should not be construed as an inflexible limitation on the scope of the subject disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages and characteristics of the exemplary embodiments of the subject disclosure may be combined in any suitable manner in one or more embodiments. One skilled in the relevant art will recognize, in light of the description herein, that the subject disclosure can be practiced without one or more of the specific features or advantages of a particular exemplary embodiment. In other instances, additional features and advantages may be recognized in certain embodiments that may not be present in all exemplary embodiments of the present disclosure.

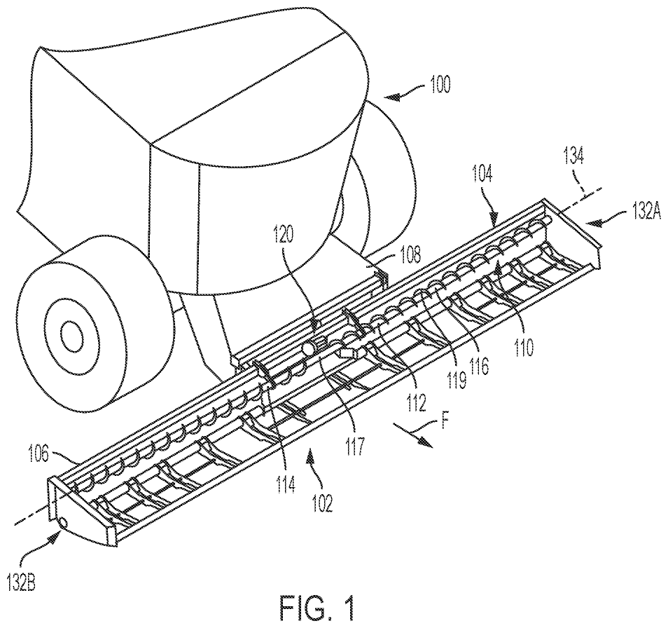

Referring now to the drawings, FIG. 1 illustrates a front view of an exemplary embodiment of an agricultural harvester 100. The agricultural harvester e.g., a combine harvester 100, includes a header 102 having a chassis 104 that is attached to a forward end of the harvester. Typically, the combine harvester 100 will include additional internal systems for the separation and handling of collected crop material. However, these additional systems are not essential for a full understanding of the subject disclosure.

The header 102 is coupled to a feeder housing 108 and supported by the chassis 104 of the agricultural harvester 100. The header 102 may further include a rotating reel with tines or the like to sweep the crop material inwardly, e.g., a windrower, or may alternatively be configured as a corn header with a plurality of row units. The header 102 may also support one or more cutter bars to cut crop material as the agricultural vehicle 100 travels in a forward direction, denoted by arrow F.

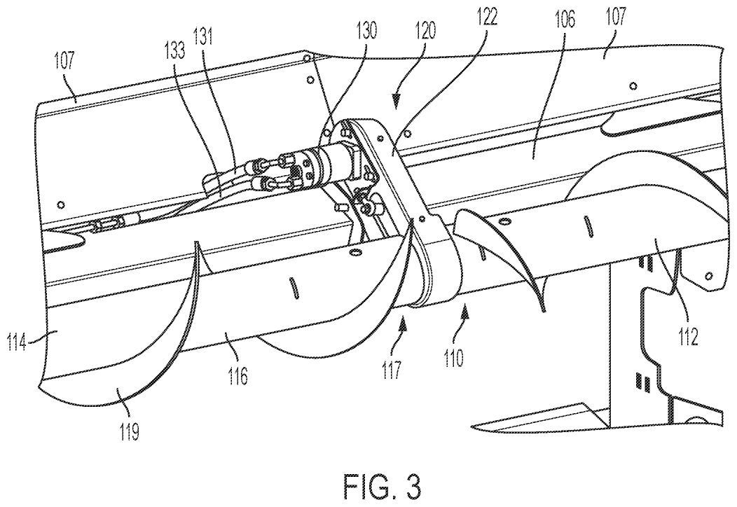

Referring now to FIGS. 1-5, the chassis 104 includes a top support beam 106 (FIGS. 3-5) extending transversely across a widthwise length of the header and a pair of opposed lateral ends 132A, 132B. While generally continuous, the top support beam 106 can be sectional in construction. The header 102 further comprises a backsheet 107 mounted to a posterior end of the top support beam 106 of the chassis 104.

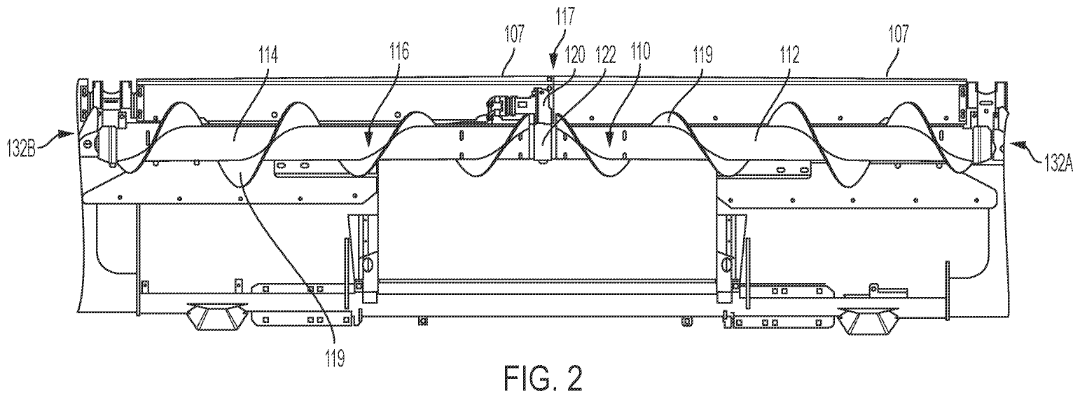

Referring again to FIGS. 1 and 2, the chassis 104 rotatably supports a multi-segment auger 110 (also known as a compression auger). The multi-segment auger 110 extends widthwise across the chassis 104 and adjacent the top support beam 106. In the exemplary embodiment, the auger 110 includes a first auger segment 112 and a second auger segment 114 extending in substantially end to relation or in end to end relation with the chassis 104. The auger 110 also includes a segmented tube 116. It is to be understood that the auger can be sectional or segmented and connected with shafts and/or universal joints in order to enable relative motion between adjacent segments of the auger.

The header 102 further includes a drive assembly 120 centrally located with respect to the chassis 104 for rotatably driving the multi-segment auger 110. Specifically, the drive assembly 120 is mounted adjacent a mid-portion 117 of the auger 110 and operatively engaged with the mid-portion of the multi-segment auger 110 for driving rotation thereof. In an aspect, a medial end of the first auger segment 112 is spaced from a medial end of the second auger segment 114 about 2 to 7 inches, and preferably about 4 to 5 inches, including 1.5, 2.5, 3, 3.5, 4.5, 5.5, 6, 6.5, 7.5, 8, 9 and 10 inches. It should be appreciated that the auger described and illustrated herein does not necessarily need to be included on headers for combine harvesters, but can be incorporated in other types of agricultural vehicles or devices having similar uses for such augers.

The auger tube 116 extends an entire width of the auger 110. The auger 110 also includes flighting 119 on the auger tube 116 and an axis of rotation 134 about which the auger 110 rotates about. The flighting 119 of the auger may include left and right flighting that extends substantially to the mid-portion of the header or adjacent to or abutting the medial ends of the respective first and second auger segments.

Referring now to FIGS. 3-5, there is shown on an enlarged scale, the auger 110, auger tube 116 and drive assembly 120 constructed in accordance with an exemplary embodiment of the subject disclosure. The drive assembly 120 directly engages the auger 110. Specifically, the drive assembly directly engages the medial ends of the first and second auger segments. In the exemplary embodiment, the drive assembly 120 includes a motor 130 spaced from the multi-segment auger 110 and a driven shaft 138 operatively engaged with the motor 130, and the first and second auger segments 112, 114.

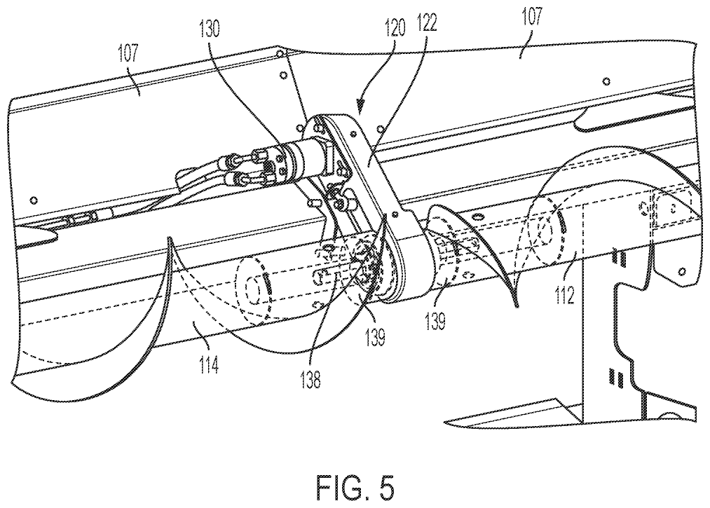

The motor 130 may be a hydraulic, pneumatic, or electric motor operatively engaged with the driven shaft 138 and the first and second auger segments 112, 114. As shown in FIGS. 2-5, the motor 130 is positioned posteriorly of and spaced from a longitudinal centerline of the multi-segment auger 110. Placing the motor 130 offset from the centerline of the multi-segment auger 110 reduces the overall width required for the drive assembly 120. That is, the reduced width allows the first and second auger segments 112, 114 to be moved closer to one another and avoids the need for additional drive elements or multiple motors that require space between the auger segments. By minimizing the dead space between the respective auger segments where cut crop is unable to be effectively compressed and conveyed by the auger, the likelihood of material hesitation or stalled crop during operations is reduced. As further discussed below, the driven shaft 138 operatively engages an inner surface or inner portion of the auger, e.g., the inner surface of the auger tube 116 of the first and second auger segments 112, 114 (FIG. 5). That is, the driven shaft 138 engages first and second auger segments 112, 114 for driving rotation thereof.

Referring now to FIGS. 5-8, the drive assembly 120 further includes a housing 122, a first sprocket 124 and a second sprocket 126 housed within the housing 122, and an endless belt 128 extending between the first and second sprockets. That is, the second sprocket 126 is operatively engaged with the first sprocket 124 via the endless belt 128 extending between the first and second sprockets. As further discussed below, the motor 130 is positioned adjacent a posterior end of the housing 122 and the driven shaft 138 is operatively engaged with one of the first and second sprockets 124, 126. The housing can be a hermetically sealed housing.

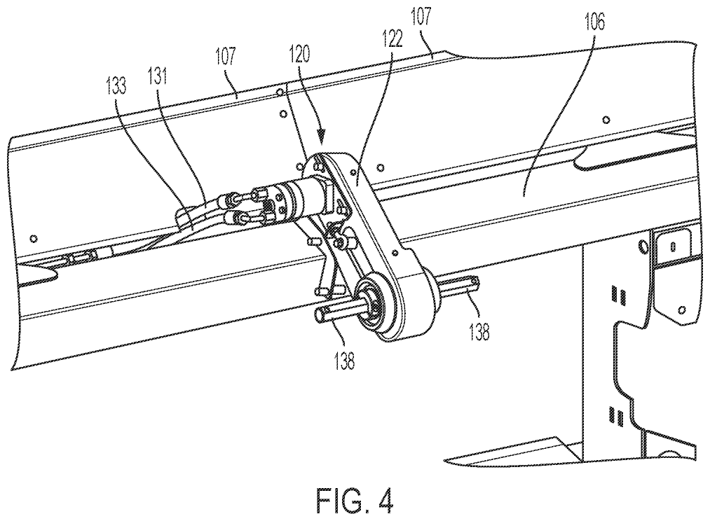

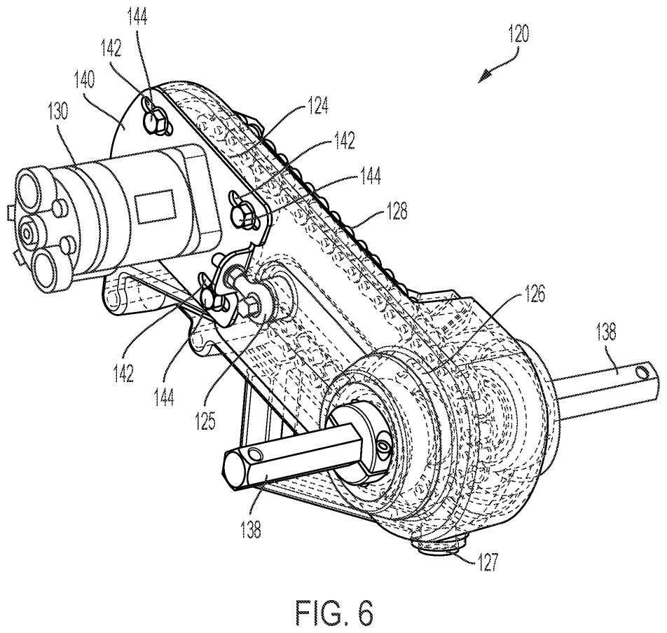

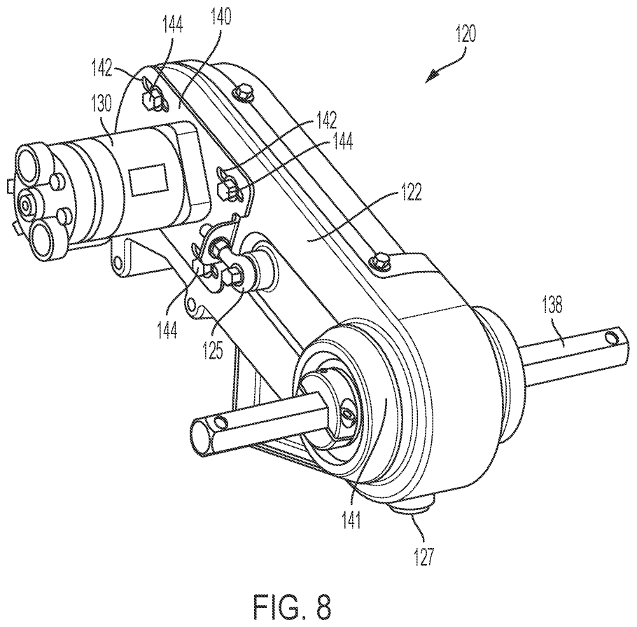

As best shown in FIGS. 3 and 4, the housing 122 is mounted to the top support beam 106 of the chassis 104. Specifically, the housing 122 is positioned between the first and second auger segments 112, 114. That is, the housing 122 is secured to the mid-portion 117 of the auger 110. The drive assembly 120 also includes a hydraulic fluid inlet 131 and a hydraulic fluid outlet 133, each of which are in fluid communication with an interior of the housing 122. The housing 122 further includes a removable plug 127 (FIGS. 6-9) for removing debris from an interior of the housing. During harvesting operations, the interior of the housing 122 can become plugged with crop debris and other residue that needs to be cleaned out. The removable plug 127 allows the operator to easily access the interior of the housing to efficiently clear the debris without having to take apart the entire drive assembly 120. In accordance with an aspect, the auger tube 116 is seated on an annular flange 141 (FIG. 8) of the housing 122.

FIGS. 2-5 show the general shape of the housing 122 of the drive assembly 120 of the present exemplary embodiment of the subject disclosure. As previously discussed, the motor 130 is spaced from the longitudinal centerline of the multi-segment auger 110. The housing 122 is a generally elongated substantially planar housing configured to have a minimal width or alternatively its width is minimized. The narrow width of the housing 122 reduces the amount of dead space on the auger 110 containing no flighting 119. By reducing the dead space, the likelihood of material hesitation or stalled crop during operations is reduced. The housing, as best shown in FIG. 3 is configured to fit between the spacing between the first and second auger segments. In the present embodiment, the housing completely fills the gap between the first and second auger segments.

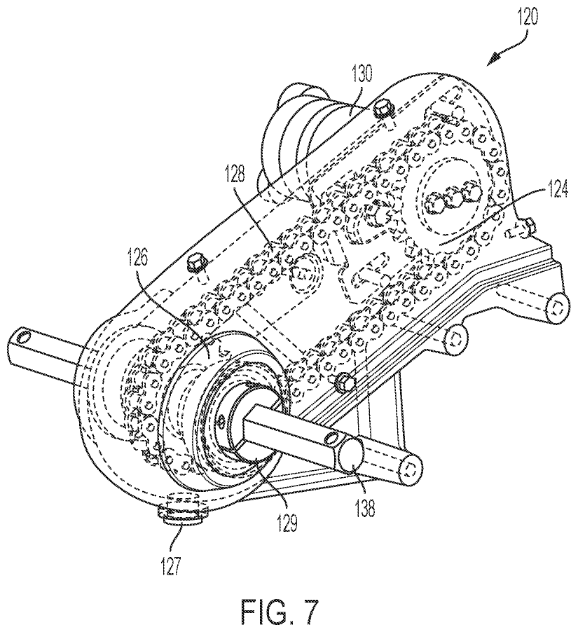

Referring now to FIGS. 6 and 7, the drive assembly 120 includes first sprocket 124 i.e., the driver sprocket about a posterior end of the housing 122 and second sprocket 126 i.e., the driven sprocket about an anterior or forward end of the housing. The endless belt 128 extends between the first and second sprockets 124, 126. In accordance with an aspect, the endless belt 128 can be a chain belt, a planar belt, or a cog belt. The driven shaft 138 is operatively engaged with the second sprocket 126.

As shown in FIGS. 5-8, the driven shaft 138 extends laterally outwardly from both the left and right sides of the housing 122 for engaging respective first and second auger segments 112, 114. Specifically, the driven shaft 138 operatively engages corresponding driven shaft receptacles on the medial ends of the auger, e.g., the medial ends of the first and second auger segments 112, 114, such that the driven shaft is fixedly secured to the first and second auger segments for driving rotation thereof. In accordance with an aspect, the driven shaft 138 includes a shoulder 139 (FIG. 5) for axially securing the driven shaft in a fixed position. The shoulder 139 is rigidly attached to the inner surface of the auger tube 116 so as to rotate therewith.

As shown in FIGS. 6-9, the driven shaft 138 is generally an elongated shaft having a longitudinal central axis and a hexagonal cross-section. However, the driven shaft 138 can have any shaped cross-section such as circular, oval, polygonal or any other shape suitable for its intended purpose. The driven shaft 138 can also be formed with a plurality of shaft segments having different cross-sectional diameters. Preferably, the driven shaft 138 has a uniform cross-sectional overall diameter.

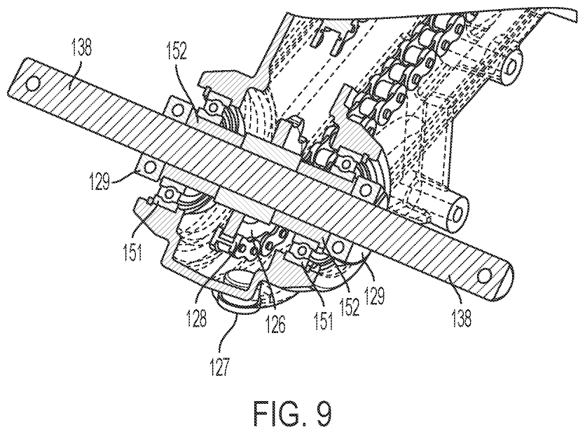

The driven shaft 138 is axially secured to one of the first and second sprockets e.g., the second sprocket 126 in the embodiment shown in FIG. 7, with a hex clamp 129. As shown in FIGS. 6 and 7, the driven shaft 138 is axially secured to the second sprocket 126 via hex clamps 129. For purposes of clarity and ease of reference, FIG. 9 illustrates a partial cross-sectional view of the drive assembly 120 and its components. The drive assembly 120 includes hex clamps 129 adjacent respective support bearings 151 positioned on each side of the second sprocket 126. In accordance with an aspect, the drive assembly includes a plurality of bushings 152 positioned throughout the drive assembly to provide minimal gaps for maintaining axial position. The bushings 152 are preferably positioned between the hex clamp 129 and the second sprocket 126.

Referring now to FIGS. 6 and 8, the drive assembly 120 further includes a mounting plate 140 for mounting the motor 130 to the housing 122. In accordance with an aspect, the mounting plate 140 is adjustably movable relative to the housing 122. Specifically, the mounting plate 140 is configured as a rectangular plate with elongated slots 142 for receiving a fastener 144. The fasteners can be any fastener suitable for their intended purpose, e.g., screws, pins, bolts, for affixing the mounting plate to the housing. The elongated slots 142 allow for adjustable positioning of the mounting plate 140. In accordance with an aspect, the mounting plate 140 is movable relative to the fastener 144 along a length of the elongated slot 142. That is, the fastener 144 fastens to the housing 122 through the elongated slot 142 allowing the mounting plate 140 to slidably or adjustably move along the length of the elongated slot.

The drive assembly 120 further includes a belt tensioner 125 configured as an eyebolt for adjusting a tension of the endless belt 128. Specifically, the belt tensioner 125 facilitates adjustment of the positioning of the mounting plate 140 to maintain or adjust the tension of the endless belt. That is, as the mounting plate moves posteriorly, the endless belt's tension is increased as the entire first sprocket is moved posteriorly or away from the second sprocket.

Additionally, it is appreciated that the motor 130 of the drive assembly 120 may be positioned at an angle other than parallel with respect to the longitudinal centerline of the multi-segment auger 110. In such an aspect, a relative angle between the motor of the drive assembly and the multi-segment auger may be fixed at assembly of the header or may be adjustable by an operator during harvesting operations.

In operation, the motor 130 transfers motion to the auger 110 via the endless belt 128. The auger 110 rotates via rotational motion provided by the hydraulically powered motor connected to the driver sprocket (i.e., first sprocket 124), which forces the driven sprocket (i.e., second sprocket 126) to rotate. Consequently, the driven shaft 138 and auger segments 112 and 114 also rotate.

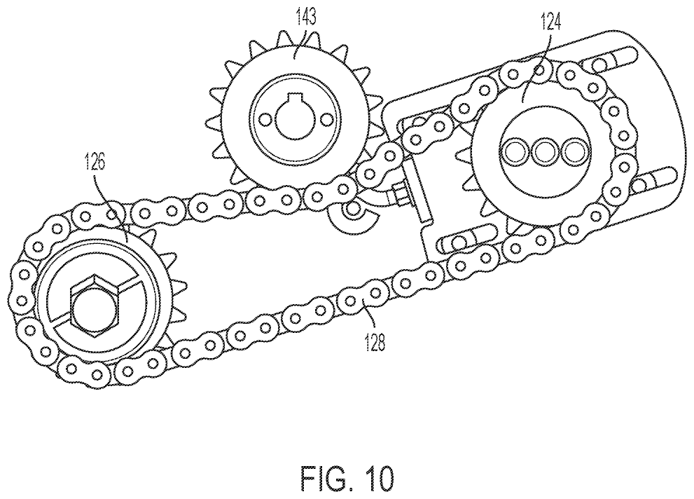

In accordance with another exemplary embodiment shown in FIG. 10, the drive assembly 120 further includes an idler sprocket 143 for adjusting tension of the endless belt 128. Additionally, although both the first and second sprockets 124, 126 have the same number of teeth and provide a 1:1 speed ratio of the motor shaft to the driven shaft 138, it is to be understood that this ratio can be adjusted to e.g., 1:1.5, 1:2.0, 1:2.5 or more, to accommodate speeding up or slowing down of harvesting operations.

In accordance with another exemplary embodiment of the subject disclosure, the multi-segment header includes the chassis and the multi-segment auger supported by the chassis, and further consisting essentially of a drive assembly centrally located with respect to the chassis for rotatably driving the multi-segment auger and including a motor spaced from the multi-segment auger and a driven shaft operatively engaged with the motor.

The advantages of having a drive assembly with an offset motor spaced from the longitudinal centerline of the auger are apparent. Specifically, dead space between respective segments of the multi-segment auger is minimized. As a result, there is less material hesitation or stalling in the field during harvesting operations. Moreover, because the subject disclosure allows for motion to be transferred to both ends of the driven shaft, a single hydraulic motor can be utilized instead of multiple hydraulic motors. That is, by simplifying the design to only have one motor instead of two motors, the space between the respective first and second auger segments is minimized.

It will be appreciated by those skilled in the art that changes could be made to the exemplary embodiments described above without departing from the broad inventive concept thereof. It is to be understood, therefore, that the subject disclosure is not limited to any particular exemplary embodiments disclosed, but it is intended to cover modifications within the spirit and scope of the subject disclosure as defined by the appended claims.

I/We claim:

1. A multi-segment header for an agricultural harvester comprising:
a chassis;
a multi-segment auger supported by the chassis, the multi-segment auger including a first auger segment and a second auger segment; and
a drive assembly centrally located with respect to the chassis for rotatably driving the multi-segment auger, the drive assembly including:
a motor spaced from the multi-segment auger, and
a driven shaft operatively engaged with the motor, and the first and second auger segments.

2. The multi-segment header of claim 1, wherein the drive assembly further comprises:
a housing;
first and second sprockets housed within the housing; and
an endless belt extending between the first and second sprockets,
wherein the motor is adjacent a posterior end of the housing, and the driven shaft is operatively engaged with one of the first and second sprockets.

3. The multi-segment header of claim 2, wherein the drive assembly further comprises a belt tensioner for adjusting a tension of the endless belt.

4. The multi-segment header of claim 2, wherein the driven shaft extends laterally outwardly from both the left and right sides of the housing for engaging respective first and second auger segments.

5. The multi-segment header of claim 2, wherein the driven shaft is axially secured to one of the first and second sprockets with a hex clamp.

6. The multi-segment header of claim 2, wherein the housing comprises a removable plug for removing debris from an interior of the housing.

7. The multi-segment header of claim 2, wherein the drive assembly further comprises an idler sprocket for adjusting tension of the endless belt.

8. The multi-segment header of claim 2, wherein the driven shaft includes a shoulder for axially securing the driven shaft in a fixed position.

9. The multi-segment header of claim 2, wherein the housing is positioned between the first and second auger segments.

10. The multi-segment header of claim 1, wherein the motor is a hydraulic, a pneumatic or an electric motor.

11. The multi-segment header of claim 1, wherein the motor is positioned posteriorly and spaced from a longitudinal centerline of the multi-segment auger.

12. The multi-segment header of claim 2, wherein the drive assembly further comprises a mounting plate for mounting the motor to the housing.

13. The multi-segment header of claim 12, wherein the mounting plate is adjustably movable relative to the housing.

14. The multi-segment header of claim 12, wherein the mounting plate includes an elongated slot for receiving a fastener.

15. The multi-segment header of claim 14, wherein the mounting plate is movable relative to the fastener along a length of the elongated slot.

16. The multi-segment header of claim 1, wherein a medial end of the first auger segment is spaced from a medial end of the second auger segment about 2 to 7 inches.

17. An agricultural harvester comprising the multi-segment header of claim 1.
